(19) United States
(12) Patent Application Publication
(10) Pub. No.: US 2016/0098253 A1
(43) Pub. Date: Apr. 7, 2016

(54) DELIVERING AND DEPLOYING SERVICES IN MULTI-SERVER LANDSCAPES

(71) Applicants: Daniel Hutzel, Karlsruhe (DE); Volker Driesen, Heidelberg (DE); Andreas Jahr, Karlsruhe (DE)

(72) Inventors: Daniel Hutzel, Karlsruhe (DE); Volker Driesen, Heidelberg (DE); Andreas Jahr, Karlsruhe (DE)

(21) Appl. No.: 14/508,503

(22) Filed: Oct. 7, 2014

(51) Int. Cl. G06F 9/44

(52) U.S. Cl. CPC G06F 8/34; G06F 8/22

(57) ABSTRACT

Methods, systems, and computer-readable storage media for development and deployment of a product to a multi-server landscape. In some implementations, actions include receiving first user input defining a product and indicating two or more components that the product includes, receiving second user input including a project definition of a project, the project being associated with development and deployment of the product to a multi-server landscape, the second user input indicating respective IDEs used to develop the two or more components, and receiving third user input, and in response to the third user input, automatically: providing metadata indicating the project, constituent components of the product, and one or more run-time environments for deployment of constituent components, receiving the two or more components respectively developed using the two or more IDEs, and generating a product package including the metadata and the two or more components.

### BACKGROUND

Entities, such as software developers and/or vendors, provide software and services. Some entities operate a multi-server landscape, within which platforms and applications servers are used to build software products. In some examples, products can include components for disparate platforms and/or can be provided in disparate computer-programming languages. At deploy-time, products are deployed to, e.g., installed on, systems within which they will execute during a run-time. At run-time, a product becomes a composition of run-time artifacts on different platforms. The run-time artifacts have dependencies during run-time, but also during deploy-time. For example, the order, in which components are deployed can depend on one another.

In some instances the run-time artifacts for different run-times are packaged in separate archives, one for each run-time. Consequently, each archive is individually downloaded separately, e.g., supported by a download service, and several software tools are called to deploy archived packages. A deployment sequence is not be defined by metadata and the deployment process is manually controlled.

### SUMMARY

Implementations of the present disclosure include computer-implemented methods for development and deployment of a product to a multi-server landscape. In some implementations, actions include receiving first user input defining a product and indicating two or more components that the product includes, receiving second user input including a project definition of a project, the project being associated with development and deployment of the product to a multi-server landscape, the second user input indicating respective IDEs used to develop the two or more components, and receiving third user input, and in response to the third user input, automatically: providing metadata indicating the project, constituent components of the product, and one or more run-time environments for deployment of constituent components, receiving the two or more components respectively developed using the two or more IDEs, and generating a product package including the metadata and the two or more components. Other implementations of this aspect include corresponding systems, apparatus, and computer programs, configured to perform the actions of the methods, encoded on computer storage devices.

These and other implementations can each optionally include one or more of the following features: providing a deployment service for execution by a run-time system; wherein actions further include transmitting the product package to the run-time system, the run-time system executing the deployment service to access the product package and perform actions including: processing the metadata to determine one or more run-time environments, to which the two or more components are to be deployed, and instructing each of the one or more run-time environments to retrieve and deploy at least one component; providing a package builder service that is executed by the one or more processors to perform the actions; in response to the third user input, automatically: identifying the two or more components as components that are to be included in the product package based on the project definition, and requesting the two or more components from the two or more IDEs, respectively; actions further include providing an integrated IDE that enables development of artifacts for respective run-time environments based on the project definition; and the integrated IDE provides perspectives to respective run-time environments, to which the two or more components are to be deployed.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example high-level architecture in accordance with implementations of the present disclosure.

FIG. 2 depicts a schematic architecture for development of a product package in accordance with implementations of the present disclosure.

FIG. 3 depicts a schematic architecture for deploying a product package in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are generally directed to development and deployment of a product to a multi-server landscape. More particularly, implementations of the present disclosure are directed to providing a combined integrated development environment (IDE), also referred to as an integrated IDE, for developing a product, a deploy service for deploying a product to a multi-server landscape, and a product package that is used by the deploy service to deploy the product. In some examples, a product builder service with the integrated IDE is used to create the product package including a plurality of components and metadata. In some implementations, the integrated IDE enables development of artifacts for respective run-time environments based on a single development project, or project definition, that identifies components for different run-times. In some examples, a package builder service uses the project definition and assembles the product package out of components provided from the different IDEs. In some implementations, the deploy service processes the product package and identifies the components, e.g., archives, artifacts, that are contained therein. In some examples, the deploy service notifies respective run-time environments to retrieve respective components from the deploy service, and the run-times are triggered in a specified sequence to deploy the respective components.

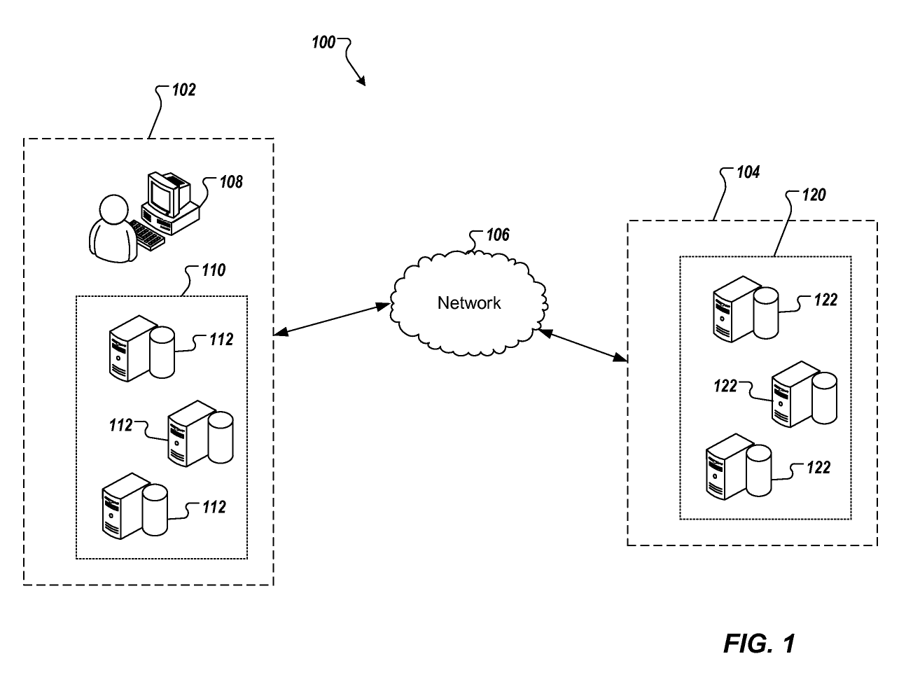

FIG. 1 depicts an example architecture 100 in accordance with implementations of the present disclosure. The example architecture 100 of FIG. 1 includes a design-time system 102, a run-time system 104 and a network 106. In the depicted example, the design-time system 102 includes a computing device 108 and a server system 110. Although a single computing device 108 is depicted, it is contemplated that a plurality of computing devices can be provided. In the depicted example, a user interacts with the computing device 108. The server system 110 includes one or more server devices 112.

In some examples, the computing device 108 can communicate with one or more of the server devices 112 over one or more networks, e.g. the network 106. In some examples, the computing device 108 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In the depicted example, the run-time system 104 includes a server system 120. The server system 120 includes one or more server devices 122.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 112, 122 includes at least one server and at least one data store. In the example of FIG. 1, the server devices 112, 122 are intended to represent various forms of servers including, but not limited to a web server, an application server, a proxy server, a network server, and/or a server pool. In general, server systems accept requests for application services and provides such services to any number of client devices, e.g., the computing device 108, over the network 106.

In some implementations, one or more data stores of the server systems 110, 120 store one or more databases. In some examples, a database can be provided as an in-memory database system. In some examples, an in-memory database is a database management system that uses main memory for data storage. In some examples, main memory includes random access memory (RAM) that communicates with one or more processors, e.g., central processing units (CPUs), over a memory bus. A memory database system can be contrasted with database management systems that employ a disk storage mechanism. In some examples, in-memory database systems are faster than disk storage databases, because internal optimization algorithms can be simpler and execute fewer CPU instructions, e.g., require reduced CPU consumption. In some examples, accessing data in an in-memory database system eliminates seek time when querying the data, which provides faster and more predictable performance than disk-storage databases.

In accordance with implementations of the present disclosure, the user of the computing device 108 can be a software developer that is developing a package using the computing device 108 and the server system 110. More particularly, and as described in further detail herein, the design-time system 102 provides an integrated IDE that enables development of artifacts for respective run-time environments, e.g., server systems 122, based on a single development project, or project definition, that identifies components for different run-times. In some examples, a package builder service uses a project definition and assembles the product package out of contributions of different IDEs. In the example of FIG. 1, the package builder service can be provided by one or more of the server devices 112, and IDEs can be provided by one or more of the server devices 112. Accordingly, the design-time system 102 can be used to provide a product package that is to be deployed to the run-time system 104.

In some implementations, the design-time system 102 and/or the run-time system 104 provides a deploy service that processes the product package and identifies the components, e.g., archives, artifacts, that are contained therein. In some examples, the deploy service notifies respective run-time environments, e.g., provided by one or more of the server devices 122, to retrieve respective components from the deploy service, and the run-times are triggered in a specified sequence to deploy the respective components.

In general, a product, also referred to as an application, can execute across multiple, disparate servers and other devices during the run-time. In some examples, a product can be described as a set of components and a set of packages. A component can be include one or more functional features of a product that are grouped together, and can include metadata that describes the component and/or a feature of the component, e.g., technical attributes, dependencies, describes what the component or feature does. A package can be described as a physical representation of the product as one or more components. Example packages can include a ZIP file, a DLL file, a WAR file

In some implementations, a product does not execute in a single application server with its underlying database, but across multiple servers and databases, e.g., a multi-server landscape. In some examples, a product having one or more components provided for a particular type of application server and database, can be extended to include one or more components for other types of application servers and/or databases. Consequently, such a product is deployed to and executes in a multi-server landscape.

For example, a product can include components provided using a particular programming language and respective run-time environment. An example programming language includes the Advanced Business Application Programming (ABAP) programming language provided by SAP SE of Walldorf, Germany. In some examples, ABAP components are developed using an ABAP server (application server) and a respective IDE, e.g., the ABAP Workbench. In some examples, the ABAP server provides an ABAP run-time environment, e.g., one or more virtual machines executing ABAP components. Another example programming language includes the Java programming language, which can be developed using a Java server, e.g., the Java Enterprise Edition (JEE) server, and a respective IDE. As another example, a real-time analytic and transactional processing system can be provided, on which one or more components can be executed. An example system includes the SAP HANA Enterprise system, which can be described as an in-memory computing appliance that combines database software with server, storage, and networking hardware. Accordingly, and using the examples above, a product can include a component written in ABAP and executed by an ABAB server, a component written in Java and executed by a Java server, and a component executed using HANA.

It is appreciated that the example programming languages, enterprise systems, application servers, databases, and IDEs explicitly discussed herein are examples, and that implementations of the present disclosure can be realized with any appropriate programming languages, enterprise systems, application servers, databases, and/or IDEs.

As described herein, the product is developed during a design-time, is deployed for production use during a deploy-time, and is executed in production during a run-time. In some examples, design-time includes creating the product, as described in further detail herein. In some examples, deploy-time includes extracting executable files from packages, storing, and installing components to enable the component functions to be executable during a run-time on a respective run-time environment. Example deploy-time activities can include installing executable programs on one or more computing devices, and loading computer-executable code into a table. The run-time environment includes computing devices, e.g., servers; data stores, e.g., databases; operating systems, and the like, which enable and/or are relied upon for execution of components of the product during the run-time. For example, one or more application servers can be included in the run-time environment, which execute code provided in the packages. As another example, an operating system of a client-side device can be included in the run-time environment, which enables the client-side device to execute functionality of the application, e.g., exposes ports, such as hypertext transfer protocol (HTTP) ports, to enable communication between the client-side device and one or more application servers.

As introduced above, implementations of the present disclosure provide an integrated IDE for developing (creating) a product that is to be deployed in a multi-server landscape. In some examples, and as described in further detail herein, the integrated IDE provides perspectives to respective run-times. More particularly, in the integrated IDE, the editors and tools for certain types of content can be grouped based on a perspective. Accordingly, and for a particular perspective, a developer can manage one set of artifacts for the product. For example, in an example perspective, database objects can be defined, their dependencies viewed and their consistency checked. In another perspective, ABAP code, classes, reports and interfaces can be created, and code checks can be run. In another perspective, a UI can be designed and linked to the services written in ABAP. In some examples, the integrated IDE is provided as one or more computer-executable programs executed by one or more computing devices. Implementations of the present disclosure further provide a deploy service for deploying a product to a multi-server landscape during a deploy-time. That is, a single deploy service is used to deploy the product to multiple run-time environments. In some examples, the deploy service is provided as one or more computer-executable programs that are executed by one or more computing devices.

Implementations of the present disclosure further provide a single delivery package, i.e., product package, for deploying the product to the multi-server landscape. Example product packages can include an installation package, a delta package and a deletion package. In some examples, the installation package is used to install a product in the multi-server landscape. In some examples, the delta package is used to update a product that is already installed in the multi-server landscape. In some examples, the deletion package is used to delete (uninstall) a product from a multi-server landscape.

As introduced above, a product is created, or developed, during a design-time, e.g., using the design-time system 102 of FIG. 1. Traditional techniques provide respective IDEs, through which products are developed. For example, a respective IDE is provided for a particular application server, on which a component of the product is to be executed. As another example, a respective IDE is provided for a particular database, with which the product will read from and/or write to. In accordance with implementations of the present disclosure development of a component is performed using the integrated IDE. In some implementations, the integrated IDE enables development of artifacts for respective run-time environments based on a single development project, or project definition, that identifies components for different run-times. In some examples, a package builder uses the project definition and assembles the product package out of contributions of the different IDEs. Accordingly, the product package is built as a composite of the archives created by the different IDEs.

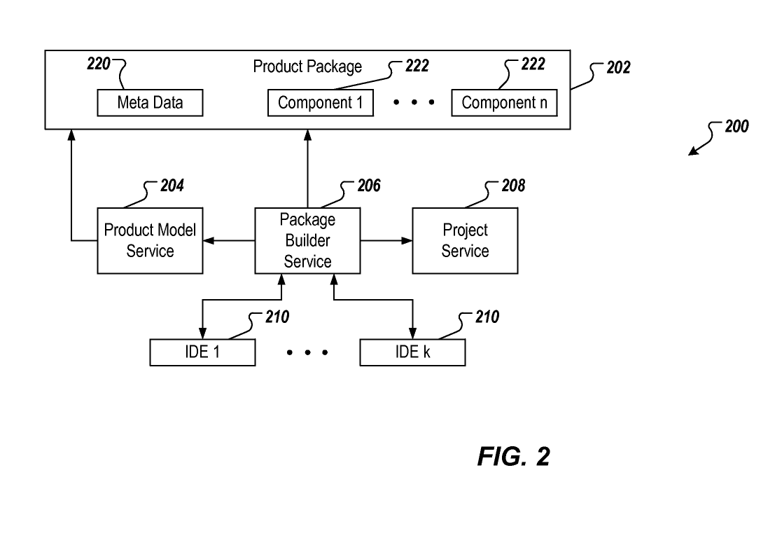

FIG. 2 depicts an example schematic architecture 200 for development of a product package in accordance with implementations of the present disclosure. In the example of FIG. 2, the schematic architecture 200 includes a product package 202, a product model service 204, a package builder service 206, a project service 208, and a plurality of IDEs 210. The product package 202 includes metadata 220, and a plurality of components 222. In some examples, the product package 202 is provided as one or more computer-readable/-writable/-executable files that can be stored in memory. In some examples, each of the product model service 204, the package builder service 206, the project service 208, and the respective IDEs 210 can be provided as one or more computer-executable that can be executed by one or more computing devices, e.g., client-side devices, server-side devices. In some examples, the product model service 204, the package builder service 206, the project service 208, and/or the plurality of IDEs 210 are provided on a developer system, e.g., the design-time system 102 of FIG. 1.

In some implementations, the package builder service 206 creates the product package 202. In general, the package builder service 206 assembles the product package 202 from the components, e.g., archives, artifacts, of the various IDEs 210 based on a project definition provided form the project service 208. In some examples, the package builder service 206 uses project information about the product, the IDEs 210, and/or the run-time environments, e.g., servers. In some examples, the package builder service 206 requests components (component packages) 222 from respective IDEs and/or servers, and aggregates the components 222 to provide the product package 202. The product package 202 is extended with the metadata 220. In some examples, the metadata 220 provides information about the product, the constituent components 222, and the required run-time environment, e.g., application server, for each component 222. In some examples, the package builder service 206 can provide dependencies between components 222. Example dependencies can include an order, in which components 222 are to be deployed relative to one another.

In some examples, the product model service 204 provides a product model that defines the product, its constituent components 222, dependencies and versioning. In some examples, the product model service 204 can receive and return the metadata 220, which is then included in the product package 202. In some examples, the project service 208 can be used to define a development project for the product. In some examples, the development project indicates the components to be included in the product and provides references to the respective IDEs and/or servers implicated by the particular project. In some examples, projects of different servers and IDEs can be registered with the project service 208. In some examples, the project service 202 provides a list, e.g., directory, of servers, from which the components of the product are to be requested for creation of the product package.

With reference to FIG. 2, an example development process in accordance with implementations of the present disclosure will be described in detail. In some examples, a developer uses the product model service 204 to provide the name of the product and the version of the product, if any, as well as identifying the components that the product is composed of. In some examples, the developer uses the project service 208 to identify which IDEs are used and which project, e.g., from a project registry provided by the project service 208, is used to create a component package. The developer, or multiple developers, use respective IDEs 210 to develop (create) the components that the product is to be made up of After the individual components have been developed, the developer triggers the package builder service 206 to create the product package 202. In some examples, the package builder service 206 receives the product model (product definition) from the product model service 204, and receives the project information and the references to the IDEs and/or servers, from which the components can be retrieved, from the project service 208. For example, component archives can be stored in a central archive repository, from which the component archives can be retrieved. The package builder service 206 retrieves component archives from respective IDEs. For example, the package builder service 206 notifies the IDEs to export respective component archives. The package builder service 206 creates the product package 202 based on the received components 222 and adds the metadata 220. The product package 202 is ready for deployment to a multi-server landscape.

In some implementations, the package builder service 204 automatically performs the described functionality. That is, after the developer triggers the package builder service 204, the package builder service 204 can build the product package 202 without further input from the developer.

As introduced above, after a product has been developed, the product is deployed to a multi-server landscape during a deploy-time. In accordance with implementations of the present disclosure, a single deploy service is provided, which processes the product package, identifies the components, e.g., archives and artifacts, contained in the product package, and notifies respective run-time environments, e.g., application service, to retrieve respective components from the deploy service. The run-time environments are triggered in a specified sequence to deploy the respective components.

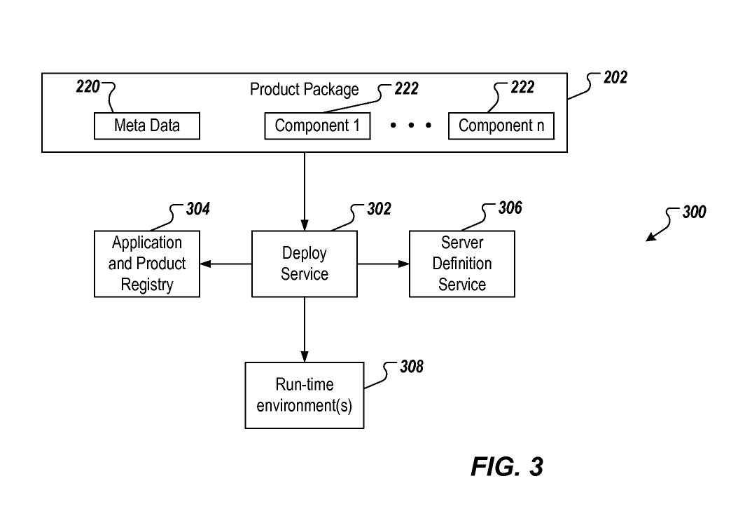

FIG. 3 depicts an example schematic architecture 300 for deploying a product package in accordance with implementations of the present disclosure. In the example of FIG. 3, the schematic architecture 300 includes the product package 202 of FIG. 2, a deploy service 302, an application and product registry 304, a server definition service 306, and one or more run-time environments 308. In some examples, each of the deploy service 302 and the server definition service 306 can be provided as one or more computer-executable that can be executed by one or more computing devices, e.g., client-side devices, server-side devices. In some examples, the application and product registry 304 is provided as one or more computer-readable/-writable/-executable files that can be stored in memory. In some examples, the deploy service 302, the application and product registry 304, the server definition service 306, and/or the one or more run-time environments 308 are provided on a customer system, e.g., the run-time system 104 of FIG. 1. As one example, a customer that seeks to deploy a product provided by a developer, can download and install the deploy service 302, which processes the product package 202 to deploy the product to the customer's run-time system, e.g., the run-time system 104 of FIG. 1.

In some examples, the deploy service 302 receives the product package 202, and coordinates the deployment process by communicating with the application and product registry 304, the server definition service 306, and the run-time environments 308. In some examples, the server definition service 306 provides a server registry that identifies servers of the run-time environments 308, their respective types and respective locations, e.g., uniform resource locators (URLs). That is, the server definition service 306 provides a landscape directory that describes the available run-time environments for deployment of the product. For example, the landscape directory can describe which technology, e.g., ABAP, Java, HANA, can be found on which host, e.g., names and/or addresses of computing devices within the multi-server landscape. In some examples, after deployment of the product, the product is registered as deployed with the application and product registry 304. The application and product registry 304 provides a product registry to maintain the product-level context for the deployed components that make up the product. In some examples, and for a particular product, the product registry describes which components are deployed and activated on which run-time environments.

With reference to FIG. 3, an example deployment process in accordance with implementations of the present disclosure will be described in detail. The product package 202 is provided to the deploy service 302. For example, the product package 202 can be stored in a data store, e.g., file system, and can be retrieved from the data store by the deploy service 302. In some examples, the deploy service 302 processes the product package 202 to extract the metadata 220. The deploy service 302 receives server instances (of the run-time environments 308, to which components are to be deployed) from the server definition service 306 based on information provided in the metadata 220. For example, and based on information provided from the server definition service 306 and the metadata 220, the deploy service 302 checks the multi-server landscape to determine servers, on which component packages are to be deployed. In some examples, the deploy service 302 can recommend run-time environments, to which the components are to be deployed. For example, a user interface (UI) can be provided that indicates one or more run-times environments that are recommended for a component. In some examples, a user can interact with the UI to select a recommended run-time environment, or select a different run-time environment for the particular component. For example, the user may decide to deploy the product and/or a component of the product to a sandboxed system, e.g., for testing before production use.

In some implementations, the deploy service 302 instructs the server instances as to where each server instance can retrieve respective component packages. In response to the instructions, each server instance requests and receives the component packages. In some examples, the deploy service 302 triggers the servers to deploy the respective component packages, e.g., copy code to a database, generate code. In some examples, deploying includes deployment of the metadata 220 and components 222, activating the metadata 220 and components 222, and configuring the activated components 222. In some examples, activation of metadata includes computing the runtime artifacts out of the provided metadata. Activation can include, for example, creating database tables, where the metadata describes how the table should look, and activation includes providing the table structure and the data definition language statement to create the table. As another example, activation can include generating computer-executable code from the metadata. As another example, components can be deployed into a run-time, but are not yet ready to be used productively by the runtime, e.g., components imported in an inactive state. In an example activation step, the components are brought into productive state, e.g., activation by setting a flag indicating that the components are now active.

The components 222 are configured, e.g. connectivity is set up. In some implementations, a sequence is provided and defines and order, in which the components 222 are deployed and/or activated. In some examples, the sequence can be controlled by the deploy service 302 and/or by the respective run-time environments 308. For example, the deploy service 302 can receive confirmation that a particular run-time environment has deployed and activated a component, and in response, can instruct another run-time environment, e.g., in the order of the sequence, to deploy and activate a component. As another example, a first run-time environment can send a notification to a second run-time environment based on the sequence, the notification indicating that the first run-time environment has deployed and activated respective components. In response, the second run-time environment can deploy and activate respective components. In this manner, run-time environments can synchronize deployment based on the sequence between themselves and/or the deploy service 302. In some examples, once a component is deployed and activated within a run-time environment, the component is registered with the run-time environment.

In some implementations, the deploy service 302 receives confirmation of deployment and activation of all components. For example, the deploy service 302 receives confirmations from respective run-time environments, and can determine whether confirmations have been received from all of the run-time environments. In response to confirmation that all components have been deployed and activated, the product is registered with the application and product registry 304.

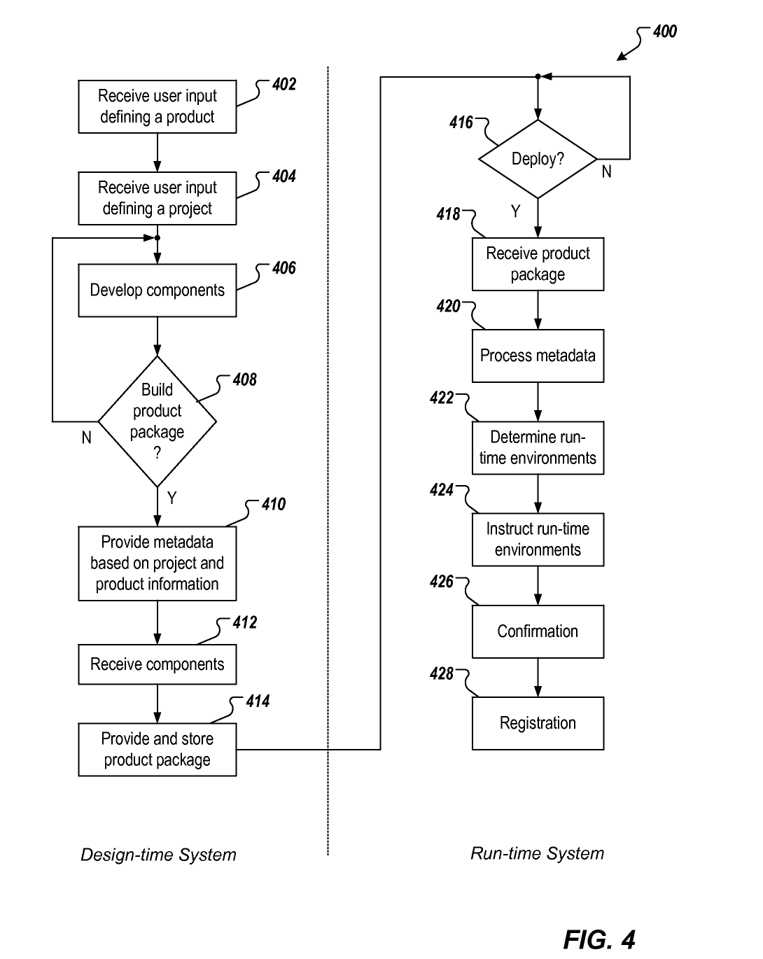

FIG. 4 depicts an example process 400 that can be executed in accordance with implementations of the present disclosure. In some examples, the example process 400 can be provided as one or more computer-executable programs executed using one or more computing devices. For example, the design-time system 102 and/or the run-time system 104 of FIG. 1 can execute the process 400.

User input defining a product is received (402). For example, user input is provided to and is received by the product model service 204 of FIG. 2. In some examples, the user input defines the product, e.g., in a computer-readable/-writable file, and indicates components of the product, dependencies between components, and/or versioning of the product. User input defining a project is received (404). For example, user input is provided to and is received by the project service 208 of FIG. 2. In some examples, the user input defines the project, e.g., in a computer-readable/-writable file, and identifies which IDEs are to be used to create respective component packages. Two or more components of the product are developed (406). For example, a developer, or multiple developers, use respective IDEs 210 of FIG. 2 to develop (create) the components that the product is to be made up of. In some examples, developed components (component packages) are stored in computer-readable memory, e.g., in a component store.

It is determined whether a product package is to be built (408). For example, a user, e.g., developer, can provide user input to the package builder service 206 of FIG. 2, indicating that a product package for a particular product is to be built. For example, the user input can include an identifier that uniquely identifies the product, for which the product package is to be built. In some implementations, in response to the user input, the package builder service can automatically perform actions, as described herein, to provide the product package without requiring further user input. Metadata is provided based on project and product information (410). For example, the package builder service 206 receives the product model (product definition) from the product model service 204, and receives the project information and the references to the IDEs and/or servers, from which the components can be retrieved, from the project service 208.

Two or more components are received (412). For example, the package builder service 206 retrieves component archives from respective IDEs. For example, the package builder service 206 notifies the IDEs to export respective component archives. The product package is provided and is stored (414). For example, the package builder service 206 creates the product package 202 based on the received components 222 and adds the metadata 220. The package builder service 206 stores the product package in computer-readable memory. The product package 202 is ready for deployment to a multi-server landscape.

It is determined whether the product is to be deployed (416). For example, a customer can access a product marketplace to download the product (product package) from computer-readable memory for installation on a multi-server landscape of the customer. If it is determined that the product is not to be deployed, the example process 400 loops back. If it is determined that the product is to be deployed, the product package is received (418). For example, a computing device of a customer-side run-time system can received the product package, e.g., from the product marketplace. Metadata of the product package is processed (420). For example, the deploy service 302 of FIG. 3 can extract the metadata from the product package and process the metadata to determine, which components are included in the product, and which type of run-time environments the components are to be deployed to and activated on. Run-time environments are determined (422). For example, the deploy service 302 of FIG. 3 receives information regarding available run-time environments from the server definition service 306, and selects run-time environments based on the required run-time environments for the product determined from the metadata.

Run-time environments are instructed to retrieve and install respective components (424). For example, the deploy service 302 can transmit computer-executable instructions to a run-time environment, which instruct the run-time environment to retrieve a specified component and install/activate the component. In some examples, instructions are provided to run-time environments based on an order, with which the components are to be installed and/or activated. Confirmation of the deployment and activation of all components is received (426). For example, the deploy service 302 can receive a confirmation message from each of the run-time environments, each confirmation message indicating that the respective component(s) ha(s/ve) been installed and activated. The product is registered (428). For example, and in response to confirmation that all components of the product have been deployed and activated, the deploy service 302 can register the product with the application and product registry 304. In some examples, the product is included in a register, which indicates each component of the product and in which run-time environment the component is installed and activated.

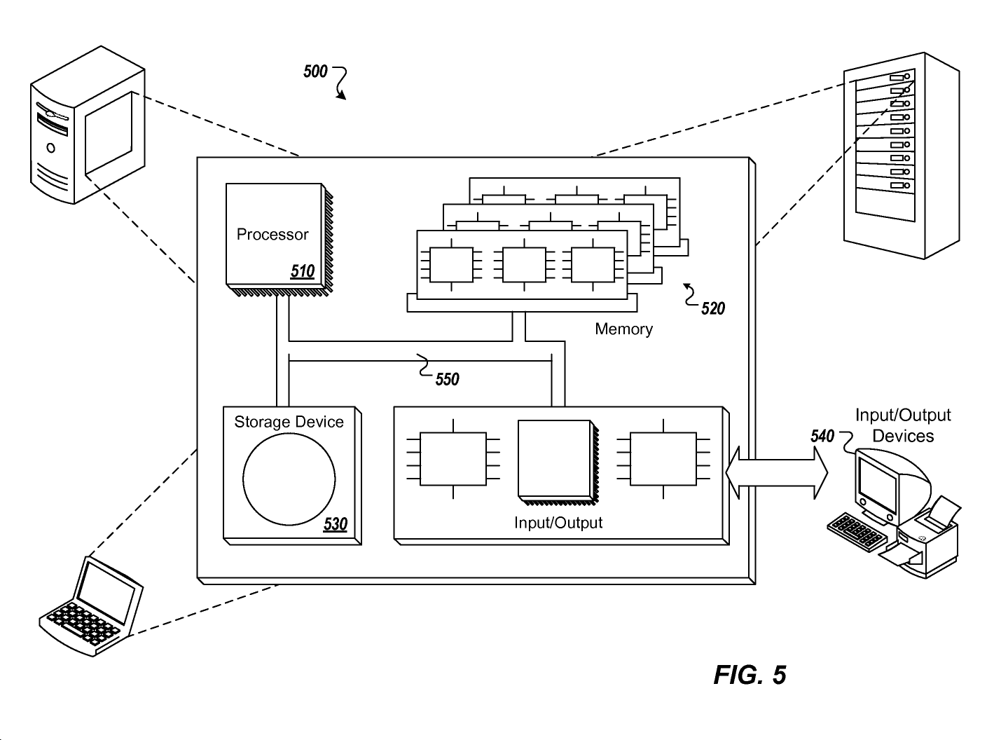

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit. The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for development and deployment of a product to a multi-server landscape, the method being executed using one or more processors and comprising:
receiving, by the one or more processors, first user input defining a product and indicating two or more components that the product comprises;
receiving, by the one or more processors, second user input comprising a project definition of a project, the project being associated with development and deployment of the product to a multi-server landscape, the second user input indicating respective integrated development environments (IDEs) used to develop the two or more components; and
receiving, by the one or more processors, third user input, and in response to the third user input, automatically, by the one or more processors:
providing metadata indicating the project, constituent components of the product, and one or more run-time environments for deployment of constituent components,
receiving the two or more components respectively developed using the two or more IDEs, and
generating a product package comprising the metadata and the two or more components.

2. The method of claim 1, further comprising providing a deployment service for execution by a run-time system.

3. The method of claim 2, further comprising transmitting the product package to the run-time system, the run-time system executing the deployment service to access the product package and perform operations comprising:
processing the metadata to determine one or more run-time environments, to which the two or more components are to be deployed; and
instructing each of the one or more run-time environments to retrieve and deploy at least one component.

4. The method of claim 1, further comprising providing a package builder service that is executed by the one or more processors to perform the operations.

5. The method of claim 1, wherein in response to the third user input, automatically, by the one or more processors:
identifying the two or more components as components that are to be included in the product package based on the project definition; and
requesting the two or more components from the two or more IDEs, respectively.

6. The method of claim 1, further comprising providing an integrated IDE that enables development of artifacts for respective run-time environments based on the project definition.

7. The method of claim 6, wherein the integrated IDE provides perspectives to respective run-time environments, to which the two or more components are to be deployed.

8. A non-transitory computer-readable storage medium coupled to one or more processors and having instructions stored thereon which, when executed by the one or more processors, cause the one or more processors to perform operations for development and deployment of a product to a multi-server landscape, the operations comprising:
receiving first user input defining a product and indicating two or more components that the product comprises;
receiving second user input comprising a project definition of a project, the project being associated with development and deployment of the product to a multi-server landscape, the second user input indicating respective integrated development environments (IDEs) used to develop the two or more components; and
receiving third user input, and in response to the third user input, automatically:
providing metadata indicating the project, constituent components of the product, and one or more run-time environments for deployment of constituent components,
receiving the two or more components respectively developed using the two or more IDEs, and
generating a product package comprising the metadata and the two or more components.

9. The computer-readable storage medium of claim 8, wherein operations further comprise providing a deployment service for execution by a run-time system.

10. The computer-readable storage medium of claim 9, wherein operations further comprise transmitting the product package to the run-time system, the run-time system executing the deployment service to access the product package and perform operations comprising:
processing the metadata to determine one or more run-time environments, to which the two or more components are to be deployed; and
instructing each of the one or more run-time environments to retrieve and deploy at least one component.

11. The computer-readable storage medium of claim 8, wherein operations further comprise providing a package builder service that is executed by the one or more processors to perform the operations.

12. The computer-readable storage medium of claim 8, wherein in response to the third user input, automatically:
identifying the two or more components as components that are to be included in the product package based on the project definition; and
requesting the two or more components from the two or more IDEs, respectively.

13. The computer-readable storage medium of claim 8, wherein operations further comprise providing an integrated IDE that enables development of artifacts for respective run-time environments based on the project definition.

14. The computer-readable storage medium of claim 13, wherein the integrated IDE provides perspectives to respective run-time environments, to which the two or more components are to be deployed.

15. A system, comprising:
a computing device; and
a computer-readable storage device coupled to the computing device and having instructions stored thereon which, when executed by the computing device, cause the computing device to perform operations for development and deployment of a product to a multi-server landscape, the operations comprising:
receiving first user input defining a product and indicating two or more components that the product comprises;
receiving second user input comprising a project definition of a project, the project being associated with development and deployment of the product to a multi-server landscape, the second user input indicating respective integrated development environments (IDEs) used to develop the two or more components; and
receiving third user input, and in response to the third user input, automatically:
providing metadata indicating the project, constituent components of the product, and one or more run-time environments for deployment of constituent components,
receiving the two or more components respectively developed using the two or more IDEs, and
generating a product package comprising the metadata and the two or more components.

16. The system of claim 15, wherein operations further comprise providing a deployment service for execution by a run-time system.

17. The system of claim 16, wherein operations further comprise transmitting the product package to the run-time system, the run-time system executing the deployment service to access the product package and perform operations comprising:
processing the metadata to determine one or more run-time environments, to which the two or more components are to be deployed; and
instructing each of the one or more run-time environments to retrieve and deploy at least one component.

18. The system of claim 15, wherein operations further comprise providing a package builder service that is executed by the one or more processors to perform the operations.

19. The system of claim 15, wherein in response to the third user input, automatically:
identifying the two or more components as components that are to be included in the product package based on the project definition; and
requesting the two or more components from the two or more IDEs, respectively.

20. The system of claim 15, wherein operations further comprise providing an integrated IDE that enables development of artifacts for respective run-time environments based on the project definition.
